(19) United States
(12) Patent Application Publication
(10) Pub. No.: US 2005/0213447 A1
(43) Pub. Date: Sep. 29, 2005

(54) Down-speed recording method for a recordable optical drive

(75) Inventor: Chien-Li Hung, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/085,565

(22) Filed: Mar. 22, 2005

(30) Foreign Application Priority Data
Mar. 26, 2004 (TW) 93108423

(51) Int. Cl. G11B 7/00

(52) U.S. Cl. 369/47.4; 369/47.55

(57) ABSTRACT

A down-speed recording method for a recordable optical drive with good recording quality. When the recordable optical drive is recording an optical disk and if an output power of a laser diode reaches a predetermined power, the recording speed or the rotating speed of a spindle motor is decreased in order to prevent the output power of the laser diode from exceeding the predetermined power, ensure the recording quality of the optical disk, and lengthen the lifetime of the laser diode accordingly.

This application claims the benefit of Taiwan application Serial No. 93108423, filed Mar. 26, 2004, the subject matter of which is incorporated herein by reference.

### BACKGROUND OF THE INVENTION

1. Field of the Invention

The invention relates in general to a down-speed recording method for a recordable optical drive capable of ensuring the recording quality, and more particularly to a method for dynamically changing the recording speed of the optical drive or the rotating speed of a spindle motor according to an output power of a laser diode in order to ensure the recording quality and lengthen the lifetime of the laser diode.

2. Description of the Related Art

Because the computer technology is rapidly developed, the recording speed of the recordable optical drive is getting faster and faster. In general, a constant relation between the output power of the laser diode and the linear velocity has to be maintained. That is, as the recording speed gets faster and faster, the required output power of the laser diode gets higher and higher.

FIG. 1A shows a relation between a linear velocity and a radius of an optical disk when a recordable optical drive is operating at a constant angular velocity. FIG. 1B shows a relation between an output power (P) of a laser diode and a radius (r) of the optical disk when the recordable optical drive is operating at the constant angular velocity. Because the constant angular velocity control is to control a spindle motor to rotate at a constant rotating speed, the linear velocity and thus the output power of the laser diode get smaller as the recording position is nearer to an inner side of the optical disk. On the contrary, the linear velocity and thus the output power of the laser diode get higher as the recording position is nearer to an outer side of the optical disk. Consequently, when the optical disk is recorded at the constant angular velocity, the output power of the laser diode has to be changed as the recording position is changed.

Although the recording speed of the optical drive can be continuously increased, the maximum output power of the laser diode is always limited. In the conventional optical drive that operates at a high constant angular velocity, the optical drive has to maintain the operation at the high constant angular velocity, as shown in the curve (I) of FIG. 1B, when the output power of the laser diode reaches its maximum (Pmax). The output power of the laser diode is higher than the maximum output power to continue recording the optical disk, and the lifetime of the laser diode is shortened accordingly. Alternatively, as shown in the curve (II) of FIG. 1B, the output power of the laser diode is only maintained at the maximum output power. In this case, the recording quality after the recording of the optical disk is finished may be influenced, or even the recording process may fail.

### SUMMARY OF THE INVENTION

It is therefore an object of the invention to provide a down-speed recording method for a recordable optical drive capable of optimizing the recording time and ensuring the recording quality of an optical disk under the limited output power of a laser diode.

The invention achieves the above-identified object by providing a down-speed recording method for a recordable optical drive. First, a spindle motor is controlled to rotate at a first constant angular velocity. Next, a laser diode is driven to emit a light beam to form a light spot on an optical disk to record the optical disk at the first constant angular velocity. Then, the laser diode is disabled from emitting the light beam when the light spot is at a first position of the optical disk and an output power of the laser diode reaches a predetermined power. Next, the spindle motor is controlled to rotate at a second constant angular velocity. Then, the laser diode is driven to emit the light beam so as to record the optical disk using the light spot after the first position at the second constant angular velocity. The output power is determined according to a position of the light spot on the optical disk, the first constant angular velocity and the second constant angular velocity. The first constant angular velocity is higher than the second constant angular velocity.

The invention also achieves the above-identified object by providing a down-speed recording method for a recordable optical drive. First, a spindle motor is controlled to rotate at a constant angular velocity. Next, a laser diode is driven to emit a light beam to form a light spot on an optical disk so as to record the optical disk at the constant angular velocity. Then, the spindle motor is controlled to rotate at a constant linear velocity when the light spot is at a first position on the optical disk and an output power of the laser diode reaches a predetermined power. Next, the laser diode is driven to output a constant power so as to record the optical disk using the light spot formed by the light beam at the constant linear velocity. The constant linear velocity is determined according to the first position and the constant angular velocity. The output power is determined according to a position of the light spot on the optical disk, the constant angular velocity and the constant linear velocity.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A shows a relation between a linear velocity and a radius of an optical disk when a recordable optical drive is operating at a constant angular velocity. FIG. 1B shows a relation between an output power of a laser diode and the radius of the optical disk when the recordable optical drive is operating at the constant angular velocity.

FIG. 2A shows a relation between a linear velocity and a radius of an optical disk in a recordable optical drive according to a first embodiment of the invention.

FIG. 2B shows a relation between an output power of a laser diode and the radius of the optical disk in the recordable optical drive according to the first embodiment of the invention.

FIG. 3A shows a relation between a linear velocity and a radius of an optical disk in a recordable optical drive according to a second embodiment of the invention.

FIG. 3B shows a relation between an output power of a laser diode and the radius of the optical disk in the recordable optical drive according to the second embodiment of the invention.

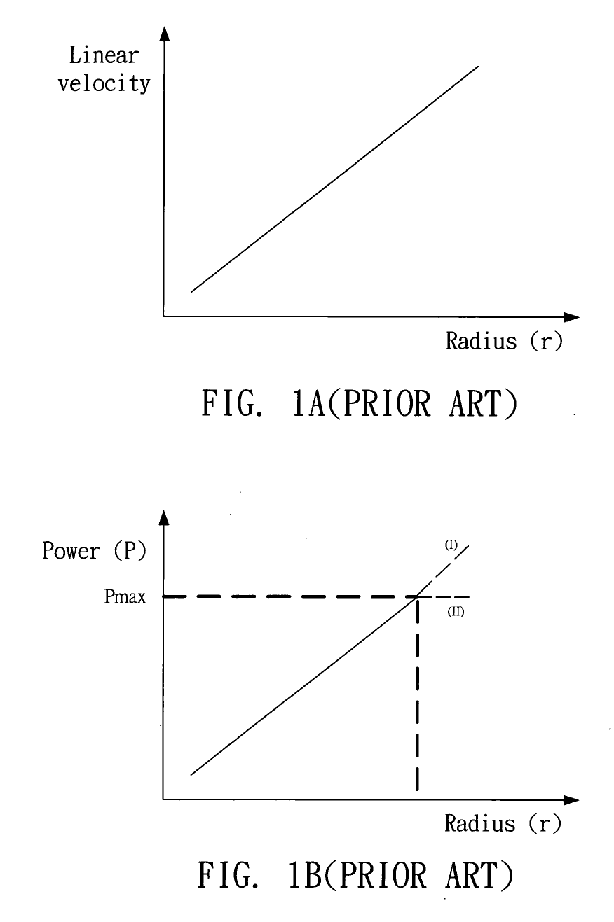

### DETAILED DESCRIPTION OF THE INVENTION

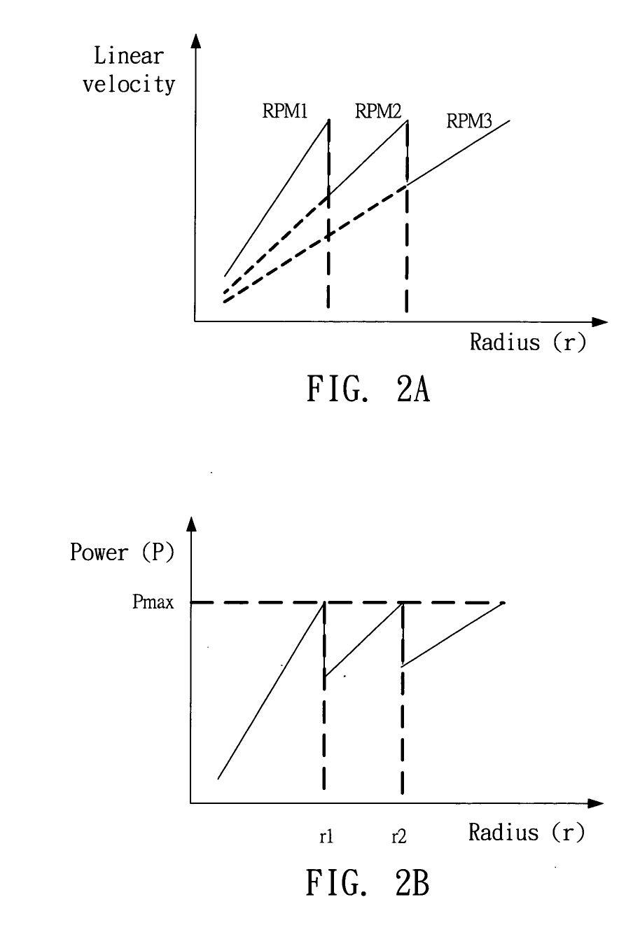

FIG. 2A shows a relation between a linear velocity and a radius of an optical disk in a recordable optical drive according to a first embodiment of the invention. FIG. 2B shows a relation between an output power of a laser diode and the radius of the optical disk in the recordable optical drive according to the first embodiment of the invention. First, the optical drive is controlled to rotate at a first constant angular velocity (RPM1). At this time, the output power of the laser diode changes with the change of the recorded position on the optical disk. That is, the linear velocity gets higher as the position is nearer to an outer side of the optical disk, and the output power of the laser diode is higher. It is assumed that the output power of the laser diode reaches a maximum (Pmax) and the recording operation pauses as the light spot, which is formed by the laser beam, is distant from the center position of the optical disk by r1.

Next, the rotating speed of a spindle motor of the optical drive decreases from the first constant angular velocity to a second constant angular velocity (RPM2), and the linear velocity at a position, which is distant from the center of the optical disk by r1, also decreases. At this time, the output power of the laser diode may be decreased. Thus, the recording operation continues after the position, which is distant from the center of the disk by r1, using the decreased output power of the laser diode.

It is assumed that the output power of the laser diode reaches the maximum again and the recording operation pauses again at a position, which is distant from the center of the optical disk by r2, when the spindle motor rotates at the second constant angular velocity. Then, the rotating speed of the spindle motor of the optical drive decreases from the second constant angular velocity to a third constant angular velocity (RPM3), and the output power of the laser diode at the position, which is distant from the center of the optical disk by r2, can be decreased. Thus, the recording operation continues after the position, which is distant from the center of the disk by r2, using the decreased output power of the laser diode. The speed-down operation is repeated analogically until the recording operation for the optical disk is finished.

According to the first embodiment of the invention, the spindle motor of the optical drive always rotates at the constant angular velocity. During the recording process, the recording operation pauses and the rotating speed of the spindle motor is decreased in order to decrease the recording speed when the output power of the laser diode at a specific position in the optical disk reaches a predetermined power. When the spindle motor reaches another constant angular velocity, the data recording process continues from the position at which the previous recording process pauses. Because the constant angular velocity has been decreased, the output power of the laser diode when the data recording process continues will be smaller than the predetermined power.

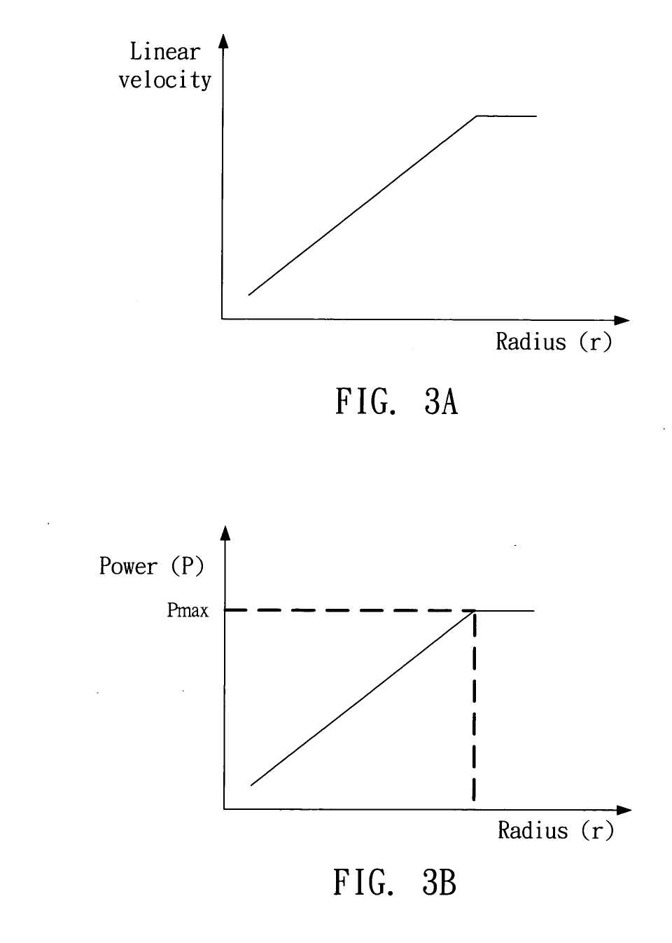

FIG. 3A shows a relation between a linear velocity and a radius of an optical disk in a recordable optical drive according to a second embodiment of the invention. FIG. 3B shows a relation between an output power of a laser diode and the radius of the optical disk in the recordable optical drive according to the second embodiment of the invention. First, an optical drive is controlled to rotate at a constant angular velocity. At this time, the output power of the laser diode changes with the change of the to-be-recorded position on the optical disk. That is, the output power of the laser diode gets larger as the position is closer to an outer side of the optical disk.

It is assumed that the output power of the laser diode reaches a maximum when the light spot formed by the laser beam is distant from the center position of the optical disk by r1. In order to prevent the output power of the laser diode from exceeding its maximum power, the spindle motor control for the recordable optical drive changes to the constant linear velocity control until the recording process of the optical disk is finished. As shown in the drawings, the rotating speed control for the spindle motor after the position, which is distant from the center of the optical disk by r1, is the constant linear velocity control, so the output power of the laser diode may be maintained at its maximum output power without exceeding its maximum output power. According to the second embodiment of the invention, the constant linear velocity control may be made at any speed. That is, when the laser diode reaches the maximum power, the linear velocity may serve as the linear velocity for the constant linear velocity control of the spindle motor.

According to the second embodiment of the invention, the spindle motor of the optical drive is switched from the constant angular velocity to the constant linear velocity. During the recording process, when the output power of the laser diode at a specific position in the optical disk reaches a predetermined power, the linear velocity at this time serves as the linear velocity for the constant linear velocity operation of the spindle motor. Thus, it is possible to ensure that the output power of the laser diode is maintained below the predetermined power during the recording process of the optical disk.

Thus, the advantage of the invention is to provide a rotating speed control method for the optical drive during the record process. When the recordable optical drive is recording the optical disk and the output power of the laser diode reaches a predetermined power, the rotating speed of the spindle motor is decreased such that the output power of the laser diode is maintained below the predetermined power and the recording quality of the optical disk is ensured to be stable.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A down-speed recording method for a recordable optical drive, the method comprising:
controlling a spindle motor to rotate at a first constant angular velocity;
driving a laser diode to emit a light beam to form a light spot on an optical disk to record the optical disk at the first constant angular velocity;
disabling the laser diode from emitting the light beam when the light spot is at a first position of the optical disk and an output power of the laser diode reaches a predetermined power;
controlling the spindle motor to rotate at a second constant angular velocity; and
driving the laser diode to emit the light beam so as to record the optical disk using the light spot after the first position at the second constant angular velocity, wherein
the output power is determined according to a position of the light spot on the optical disk, the first constant angular velocity and the second constant angular velocity, and the first constant angular velocity is higher than the second constant angular velocity.

2. The method according to claim 1, wherein the predetermined power is a maximum power of the laser diode.

3. A down-speed recording method for a recordable optical drive, the method comprising:
controlling a spindle motor to rotate at a constant angular velocity;
driving a laser diode to emit a light beam to form a light spot on an optical disk so as to record the optical disk at the constant angular velocity;
controlling the spindle motor to rotate at a constant linear velocity when the light spot is at a first position on the optical disk and an output power of the laser diode reaches a predetermined power; and
driving the laser diode to output a constant power so as to record the optical disk using the light spot formed by the light beam at the constant linear velocity, wherein
the constant linear velocity is determined according to the first position and the constant angular velocity, and the output power is determined according to a position of the light spot on the optical disk, the constant angular velocity and the constant linear velocity.

4. The method according to claim 3, wherein the predetermined power is a maximum power of the laser diode.

5. The method according to claim 3, wherein the constant power is the predetermined power.
